(19) United States
(12) Patent Application Publication
(10) Pub. No.: US 2012/0006321 A1
(43) Pub. Date: Jan. 12, 2012

(54) ARUNDO DONAX HEMICELLULOSE RECOVERY PROCESS

(75) Inventor: W. T. McKean, Seattle, WA (US)

(73) Assignee: TreeFree Biomass Solutions, Inc., Seattle, WA (US)

(21) Appl. No.: 13/042,682

(22) Filed: Mar. 8, 2011

Related U.S. Application Data
(63) Continuation of application No. PCT/US2009/056390, filed on Sep. 9, 2009.
(60) Provisional application No. 61/095,337, filed on Sep. 9, 2008.

(51) Int. Cl. C13K 13/00; D21C 3/22

(52) U.S. Cl. 127/37; 162/78; 162/90

(57) ABSTRACT

The present invention relates generally to a process for recovering hemicellulose from Arundo donax comprising extracting a hemicellulose containing fraction from an Arundo donax biomass, purifying the hemicellulose containing fraction to remove lignin and other extractives, concentrating the purified hemicellulose containing fraction, and hydrolyzing the concentrated and purified hemicellulose containing fraction to yield 5 and 6 carbon sugars.

### CROSS-REFERENCE TO RELATED APPLICATION

This application is a continuation of International PCT Patent Application No. PCT/US2009/056390, which was filed on Sep. 9, 2009, now pending, which claims the benefit under 35 U.S.C. §119(e) of U.S. Provisional Patent Application No. 61/095,337, filed Sep. 9, 2008, which applications are incorporated herein by reference in their entireties.

### BACKGROUND OF THE INVENTION

1. Field of the Invention

The present invention relates generally to a process for recovering hemicellulose from Arundo donax.

2. Description of the Related Art

The world today is facing growing burdens caused by overpopulation, depletion of fossil fuels, increasing demands for fuels, pollution of air, water and land, global warming and climate changes, forest cover destruction, and agricultural land loss. Although to some extent some of these concerns can be met through the improved use of solar energy and windpower and increased nuclear power, more conservation of resources and more efficient use of resources are always being sought.

Fibrous cellulosic material, such as straw, corn stalks (stover), bagasse, hardwoods, cotton stalks, kenaf and hemp, are composed primarily of cellulose (typically, 40-60% dry weight), hemicellulose (typically 20-40% by dry weight) and lignin (typically 5-25% by dry weight). These components, if economically separated fully from one another, can provide vital derivative sources of fermentable sugars for the production of alcohols, ethers, esters and other chemicals. There is a growing interest in the manufacture of biofuels from cellulosic biomass by fermentation with enzymes or yeast. To date, the majority of that interest has focused on the use of starch, cane and beet sugar. As used herein, biofuels refers to fuel (ethanol) for the generation of electricity and for transportation. Biofuels are beneficial in that they add fewer emissions to the atmosphere than petroleum fuels. They also are beneficial in that they use herbaceous and sparsely used woody plants and, particularly, plant wastes that currently have little or no use. Biofuels are obtained from renewable resources and can be produced from domestic, readily available plants and wastes, thus reducing dependence on coal, gas and foreign fossil fuel in addition to boosting local and world-wide economies.

To date, however, there has not been an economical method for cleanly separating the basic components of fibrous, ligno-cellulosic materials and the fermentable sugars they represent from one another. In particular, it has proved difficult to economically separate the mixed hexose and pentose structured hemicellulose from the lignin and other, minor, components, such as lipids and silica, present in biomass. The processes which exist today focus on techniques such as ball-milling, two-roll milling, cryogenic grinding, explosive depressurization, ultrasonics and osmotic cell rupture followed by ethanol extraction, as well as conventional pulping techniques. All use high levels of technology, fossil energy and investment and, accordingly, are expensive and, often, highly polluting. For example, conventional pulping processes, which use high temperatures (e.g., 175° C.) and pressure (e.g., 175 psi) and sulfite, kraft or alkali to obtain purified cellulose, known as alpha pulp, are well recognized as involving high investment, energy and operating costs, including recovery of chemicals, which are accompanied by severe problems of air and water pollution and the production of toxic materials.

Accordingly, although there have been advances in the field, there remains a need in the art for alternative cellulosic biomass materials and alternative methods for fractionating cellulosic biomass materials. The present invention addresses these needs and provides further related advantages.

### BRIEF SUMMARY OF THE INVENTION

In brief, the present invention is directed to processes for recovering hemicellulose from Arundo donax, separating the lignin and other extractives (e.g., plant extractives), and hydrolyzing the purified hemicellulose containing extract (or fraction) to a mixture of 5 and 6 carbon sugars at sufficiently high concentration for fermentation and/or hydrogenation treatments. As disclosed herein, recovery of hemicellulose and its separation from lignin and other extractives depends on minimizing hemicellulose side reactions during extraction and on retaining the hemicellulose material in a high molecular weight form (i.e., large size) during subsequent purification and concentration steps prior to conversion to 5 and 6 carbon sugars.

Due to its high biomass productivity, Arundo donax is a potentially economically viable source of pulp, as well as bioethanol and bio/petrochemical replacements such as 3 to 6 carbon glycols. All of these are in very high demand as a result of national moves to “green” products and of increased crude oil costs. As described in more detail below, prior to conventional pulping processes or as part of nonconventional pulping conditions described herein, a portion of the Arundo donax plant hemicellulose fraction may be recovered and converted to 5 and 6 carbon sugars using the disclosed integrated processes comprising various hemicellulose extraction, purification, concentration and hydrolysis steps. The 5 and 6 carbon sugars obtained according to these processes may be marketed to existing manufacturing facilities for further fuel and chemical production. While similar individual process steps have been used separately in other industries, integration and development of appropriate process conditions is required for this combination of raw material and products.

In one embodiment, a process for extracting a hemicellulose containing fraction from an Arundo donax biomass is provided, comprising treating the Arundo donax biomass in an aqueous solution at a temperature in the range of 40-130° C. and at a pH in the range of 5-12 for ½-5 hours. In certain embodiments, the Arundo donax biomass comprises Arundo donax chips.

In certain embodiments, the process yields an extracted Arundo donax biomass. In other embodiments, the process yields an Arundo donax pulp.

In certain embodiments, the aqueous solution comprises hydrogen peroxide. For example, in more specific embodiments, the aqueous solution comprises 0-10% by weight hydrogen peroxide (e.g., 0-5% by weight hydrogen peroxide).

In certain embodiments, the aqueous solution comprises sodium hydroxide. For example, in more specific embodiments, the aqueous solution comprises 0-12% by weight sodium hydroxide.

In certain embodiments, the temperature is in the range of 40-105° C. In other embodiments, the temperature is in the range of 45-130° C.

In certain embodiments, the temperature is in the range of 40 to less than 90° C., the Arundo donax biomass is treated for ½-1½ hours and the process yields an extracted Arundo donax biomass. In other embodiments, the temperature is in the range of 90-100° C., the Arundo donax biomass is treated for 1-3 hours and the process yields an Arundo donax pulp. In other embodiments, the temperature is in the range of 100-130° C., the Arundo donax biomass is treated for ½-1½ hours and the process yields an Arundo donax pulp.

In certain embodiments, the hemicellulose containing fraction comprises 10-40% by weight hemicellulose.

In a second embodiment, an integrated process for recovering hemicellulose from Arundo donax is provided, comprising: (a) extracting a hemicellulose containing fraction from an Arundo donax biomass as set forth in the embodiments above; (b) purifying the hemicellulose containing fraction to remove lignin and other extractives; (c) concentrating the purified hemicellulose containing fraction; and (d) hydrolyzing the concentrated and purified hemicellulose containing fraction to yield a 5 and 6 carbon sugar containing fraction.

In certain embodiments, steps (b) and (c) comprise a single purification and concentration step.

In certain embodiments, the process further comprises: (e) purifying the 5 and 6 carbon sugar containing fraction to remove any remaining lignin and other extractives; and (f) concentrating the purified 5 and 6 carbon sugar containing fraction.

These and other aspects of the invention will be evident upon reference to the following detailed description and attached drawings.

### BRIEF DESCRIPTION OF THE DRAWING

FIG. 1 is a schematic diagram of a first representative Arundo donax hemicellulose recovery process of the present invention.

FIG. 2 is a schematic diagram of second representative Arundo donax hemicellulose recovery process of the present invention.

FIG. 3 is a schematic diagram of a third representative Arundo donax hemicellulose recovery process of the present invention.

FIG. 4 is a schematic diagram of fourth representative Arundo donax hemicellulose recovery process of the present invention.

FIG. 5 shows hemicellulose extracted as a function of temperature, time, alkali and peroxide charge.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures and methods associated with pulping processes have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Arundo donax is one of highest known biomass producing plants. As disclosed in U.S. Pat. No. 6,761,798, Arundo donax may be used to produce pulps, paper products and particle board. In addition, and as disclosed herein, the high bioproductivity of this species may provide the basis for production of various biobased petroleum replacements.

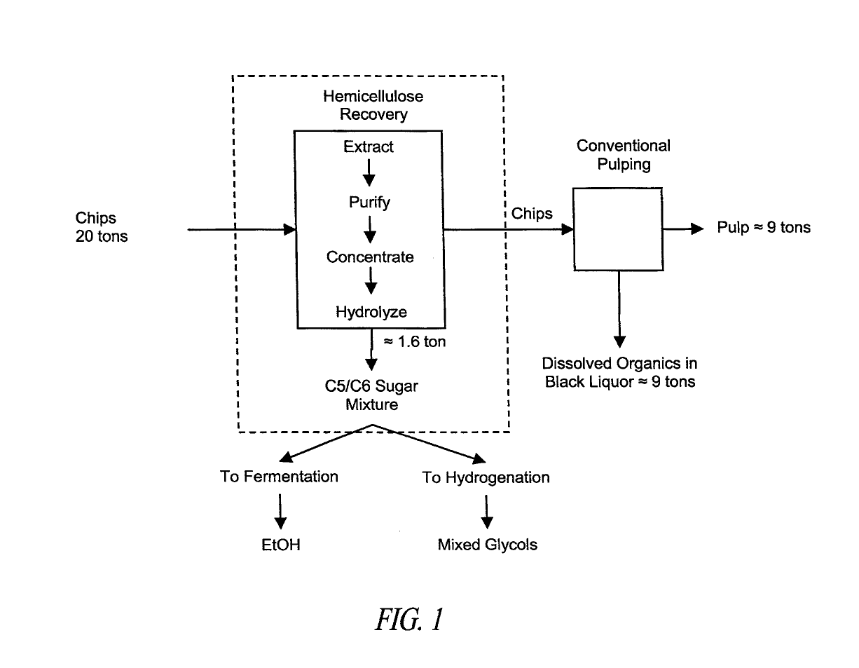

FIGS. 1-4 are schematic diagrams of representative Arundo donax hemicellulose recovery processes of the present invention. For purposes of illustration assume a biomass production of 20 dry tons of leaf/sheath free chips per acre-year. Using conventional pulping conditions, this will yield about 9 tons of pulp while about 11 tons of dissolved plant material appears in process black liquor. This dissolved organic material comprises a complex mixture derived from degradation of a portion of the hemicellulose and lignin originally present in the biomass. However, conventional pulping chemistry alters the hemicellulose and produces non-sugar degradation products that may not be used to produce fermentation ethanol or useful petroleum replacement chemicals. Thus, separation and recovery of useful hemicellulose and related simple sugars directly from this black liquor is not feasible using existing conventional techniques.

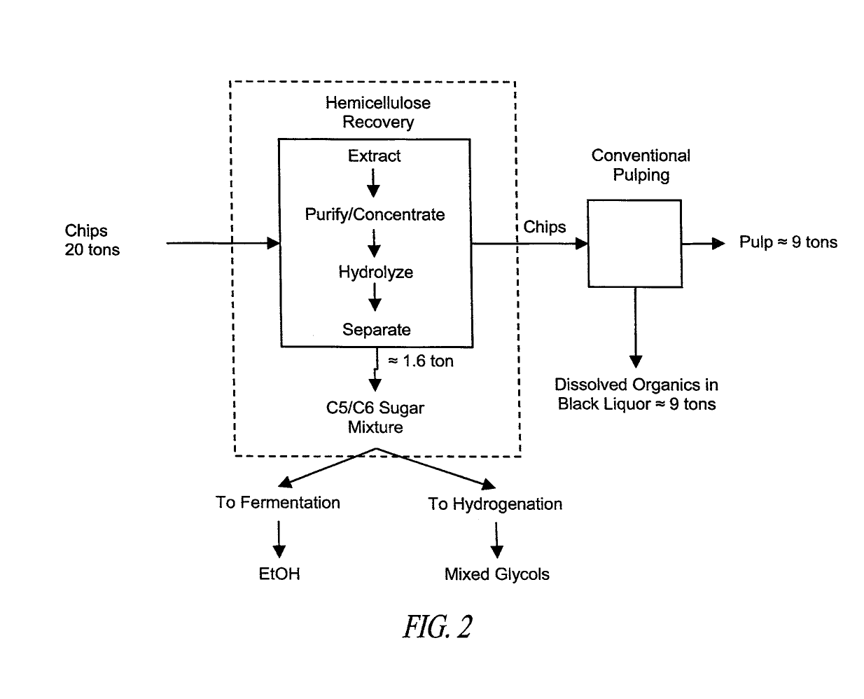

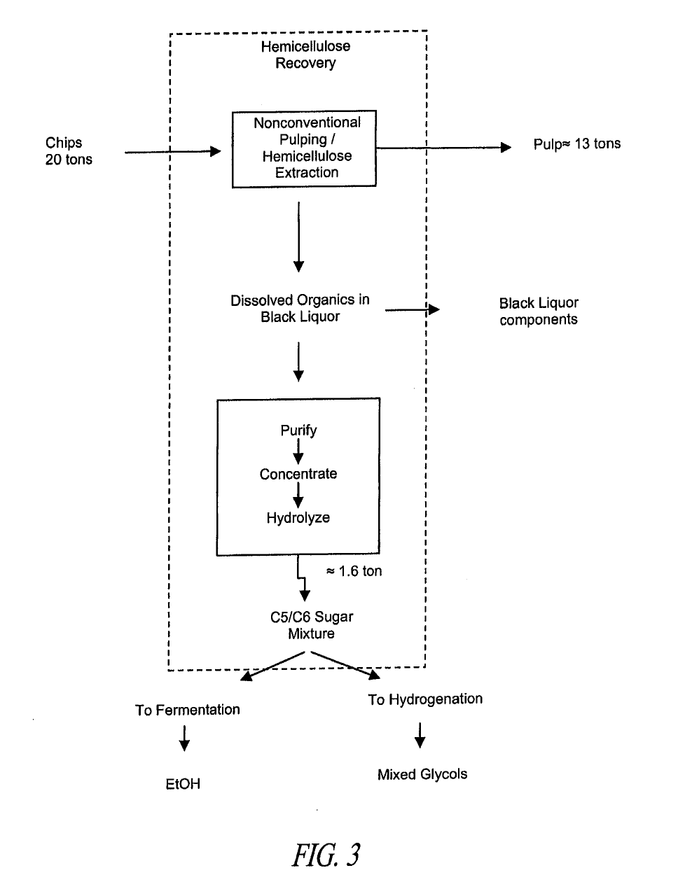

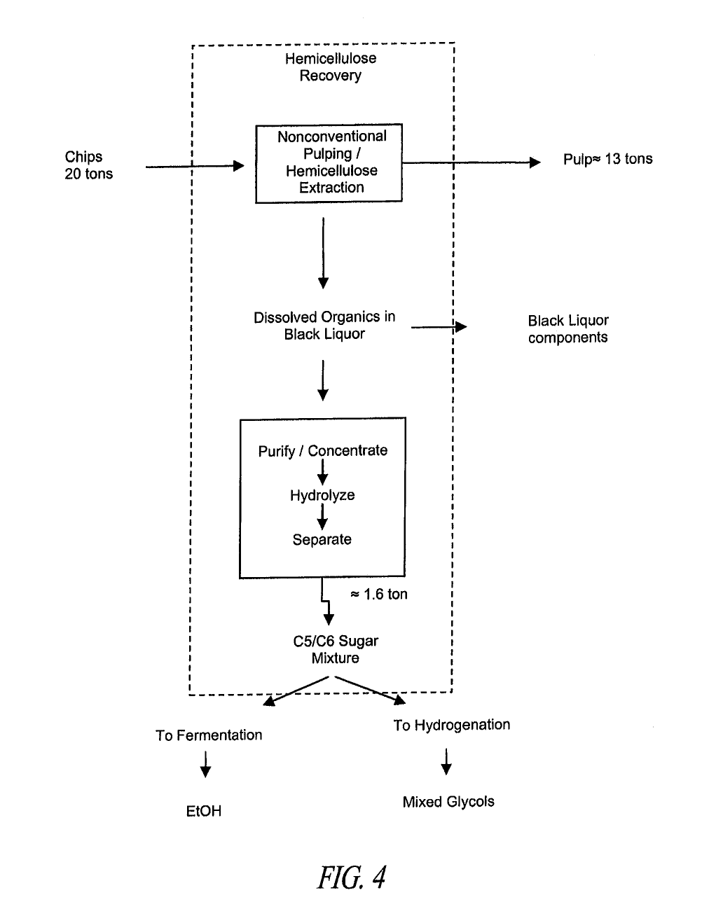

As disclosed herein, a portion of the hemicellulose may be extracted from an Arundo donax biomass prior to conventional pulping (FIGS. 1 and 2). Alternatively, as part of the hemicellulose extraction process, an Arundo donax pulp may be produced as part of a new non-conventional mild pulping process described herein (FIGS. 3 and 4). In either case, the extracted hemicellulose containing fraction is rich in soluble hemicellulose oligomers, as well as soluble lignin and other plant extractives. This extract stream may be used for production of ethanol or for a range of petrochemical replacements described later. In addition, as further disclosed herein, careful selection of the extraction conditions permits economical recovery of a hemicellulose rich liquid contaminated with relatively small amounts of lignin and plant extractives. After removal of the soluble (e.g., low molecular weight) lignin and extractives, the hemicellulose is hydrolyzed to simple 5 and 6 carbons sugars that may be subsequently fermented to ethanol or hydrogenated to a blend of glycols. The market for the former as a fuel additive is extremely large and the demand for the latter is huge since these are potential fuel additives and amount to about ¼ of the total mass of products such as polyesters and polyurethanes.

By limiting this extraction to ¼ to ⅓ of the total available hemicellulose, the extracted chips are easier to pulp by conventional pulping processes and will produce a pulp with equal properties and yield as obtained from non-extracted chips. Alternatively, the new non-conventional mild pulping process described herein may be used to produce pulp appropriate for selected paper products, while also yielding a hemicellulose containing fraction comprising about ⅔ hemicellulose and ⅓ lignin appropriate for recovery of simple sugars as disclosed herein.

Based on the above assumptions (i.e., 20 dry tons of leaf/sheath free chips per acre-year), the liquid extract stream will contain a total of about 2.0 tons of hemicellulose, lignin and extractives per acre per year. Following lignin/extractive removal, about 1.6 tons of usable hemicellulose derived sugars could be sold for fermentation or hydrogenation. As one of skill in the art will appreciate, production of ethanol or chemicals must be preceded by lignin and extractives removal. Accordingly, after purification and hydrolysis to simple sugars, the foregoing quantity of hemicellulose should produce about 0.5 ton of ethanol (by fermentation) or 1.5 tons of mixed 5 and 6 carbon sugars that could be sold to a sugar hydrogenation facility.

Again, for purposes of illustration and using the foregoing estimates, a plantation of 100,000 acres of Arundo donax could provide sufficient raw material for simultaneous production of about 900,000 tons of pulp, 16 million gallons of fuel ethanol and 300 million pounds of mixed glycols.

While similar processes to the required steps in a process sequence for hemicellulose recovery have been demonstrated elsewhere on other types of wood and non-wood furnishes, the steps disclosed herein have never been used in an integrated process sequence as shown in FIGS. 1-4. In addition, each Arundo donax furnish derives from different soil, meteorological and agronomic conditions and is different in composition and in the chemical structure in ways that will affect extraction conditions. Furthermore, the presently available purification and concentration methods of the liquid streams containing lignin, hemicellulose and related 5 and 6 carbon sugars is complex and expensive to implement. While membrane processes offer a potentially less expensive way to accomplish these two steps, conditions for the two membrane steps needed to be developed. The purification (removal of lignin and plant extractives) and concentration (removal of water and dissolved inorganic salts) steps require selection of membranes with the appropriate pore size distribution and operating conditions.

### EXAMPLES

As noted above, the integrated process of the present invention comprises a sequence of steps including chip extraction, extract purification and extract concentration, hemicellulose hydrolysis, and further purification of the 5 and 6 carbon sugar extract, followed by the possible sale to third parties for fermentation or hydrogenation of the resulting 5 and 6 carbon sugar mixture.

### Extraction Conditions to Maximize Hemicellulose Recovery while Retaining Acceptable Pulp Properties

### Range of Chip Extraction Conditions

Wet or air dried Arundo donax chips are treated in the temperature range of 40-130° C., pH range of 5-12 and with and without addition of hydrogen peroxide. Quantities of extracted hemicellulose, simple 5 and 6 carbon sugars, sugar acids, lignin and plant extractives are measured at each extraction condition. These temperature and pH ranges span the ranges at which the disclosed process is feasible without unacceptable material product property loss. The presence and absence of peroxide indicates the extent to which that oxidant will stabilize hemicellulose against peeling and yield losses by conversion to undesirable sugar acids. It also shows the impact of a mild oxidant on ability of this system to produce soluble, low molecular weight, lignin even at these mild processing conditions. The efficiency of any downstream hemicellulose purification system (discussed in the purification and concentration steps described below) depends on the ability to maintain the hemicellulose at the highest MW possible and produce soluble lignin at low MW. Finally, the comparison of results on dried and never dried chips provides guidance for harvesting and storage requirements related to chemical recovery and pulping operations.

Experimental—Extraction Step

a. Raw Material

Whole plant material harvested at any time later than about three months after onset of growth was fractionated into stem and leaf fractions for purposes of treatment to produce a hemicellulose rich extract. The stem fraction was chipped to produce chips with dimensions approximately ⅛ to 2 inches in width and ½ to 6 inches in length. Thickness of the chips were the normal thickness of the plant stem wall, amounting to about ⅛ to ½ inch depending on the age at time of harvest and on the vertical location in the stem from which the chips originated. The leaves were separated and mechanically shredded into pieces approximately ½ by ½ inch.

b. Procedure/Conditions

Chip Fractions. The Arundo donax stem chip fractions prepared as described above were extracted using the following range of conditions:

Liquid/chip ratio=3/1 to 10/1

2 to 20% by weight alkali (NaOH) based on oven dry chip weight

0 to 10% by weight hydrogen peroxide based on oven dry chip weight

40-130° C.

½ to 5 hours

These extractions were performed under atmospheric or slightly pressurized conditions up to approximately 130° C. using a batch reactor of 10 liter capacity. As one of skill in the art will appreciate, extractions could also be made at larger scale in any type of batch or continuous reactor. For example, in a single mixed tank or a series of connected tanks equipped to continuously supply and remove chips and extraction liquor. In the series configuration liquor and chips could move in co-flow or in counter-flow configuration. Alternatively, a continuous reactor could be configured as a tube with internal flights to move chips from one end of the tube to the other end while submerged in the extraction liquor. Liquor and chips could move in co-flow or in counter-flow configuration.

Leaf Fractions. The Arundo donax leaf fractions prepared as described above were treated under the following range of conditions:

Liquid/chip ratio=3/1 to 10/1

2 to 20% alkali (NaOH) based on oven dry chip weight

0 to 10% hydrogen peroxide based on oven dry chip weight

40 to 105° C.

½ to 5 hours

c. Extraction Results

The results from extraction runs using the Arundo donax stem chips are set forth in the following Table 1.

TABLE 1

| | | Peroxide | | | |
|---|---|---|---|---|---|
| | NaOH | (% on | Temp. | | Extract |
| Run No. | (% on O.D) | O.D) | (° C.) | Time (hrs) | Yield (%) |
| 1 | 10 | 5 | 90 | 2 | 11.1 |
| 2 | 10 | 5 | 90 | 1 | 14.0 |
| 3 | 10 | 5 | 52 | 4 | 14.0 |
| 4 | 10 | 5 | 90 | 1 | 14.8 |
| 5 | 5 | 5 | 90 | 1 | 8.8 |
| 6 | 5 | 5 | 90 | 1 | 9.2 |
| 7 | 2 | 5 | 90 | 1 | 5.4 |
| 8 | 10 | 5 | 57 | 2 | 10.0 |
| 9 | 2 | 5 | 52 | 2 | 5.0 |
| 10 | 10 | 0 | 90 | 2 | 14.0 |
| 11 | 5 | 5 | 56 | 2 | 5.3 |
| 12 | 10 | 5 | 55 | 1 | 9.0 |
| 13 | 5 | 0 | 57 | 1 | 6.7 |
| 14 | 5 | 0 | 56 | 2 | 7.3 |
| 15 | 3 | 5 | 50 | 2 | 5.9 |
| 16 | 3 | 0 | 53 | 2 | 6.3 |
| 17 | 10 | 5 | 106 | 1 | 11 |
| 18 | 5 | 5 | 47 | 2 | 7.9 |
| 19 | 10 | 5 | 92 | 1 | 12.2 |
| 20 | 10 | 5 | 92 | 1 | 10.1 |
| 21 | 10 | 5 | 92 | 1 | 10.6 |
| 22 | 10 | 5 | 90 | 1 | 11.0 |
| 23 | 10 | 5 | 90 | 1 | 11.6 |
| 24 | 12 | 5 | 110 | 1 | 15.0 |
| 25 | 12 | 5 | 110 | 1 | 15.1 |
| 26 | 10 | 5 | 110 | 1 | 14.5 |
| 27 | 10 | 5 | 120 | 1 | 15.3 |
| 28 | 10 | 5 | 130 | 1 | 19.1 |

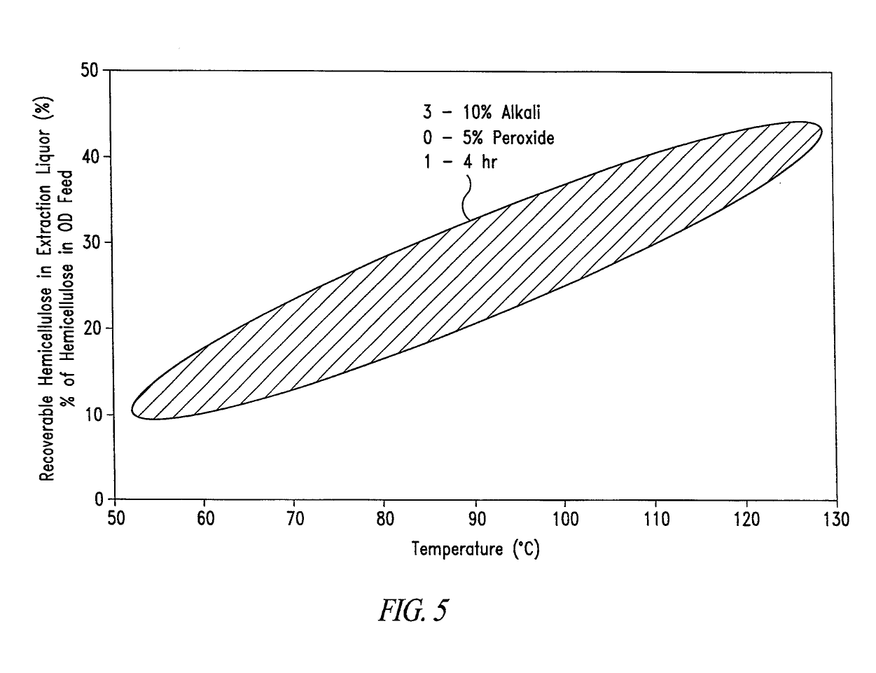

These results show that in the range of 40 to 130° C., 1-4 hours, 2 to 10% alkali and 0 to 10% peroxide from about 5 to 19% of the dry plant material can be extracted. As further shown, more severe conditions, as represented by higher alkali and peroxide concentration, higher temperature and longer time, result in greater extract yield. The soluble extracted solids are comprised of about ⅔ carbohydrate and ⅓ lignin. FIG. 5 shows the calculated hemicellulose recovery as a function of process temperature with time, alkali and hydrogen peroxide charges as parameters.

The results from extraction runs using the Arundo donax leaf fractions are set forth in the following Table 2.

TABLE 2

| | | P | Cook | | |
|---|---|---|---|---|---|
| | NaOH | (% on | Temp. | Time | Extract |
| Run No. | (% on O.D) | O.D) | (° C.) | (hrs) | Yield (%) |
| 1 | Water/pH 6.5 | | | | 20.56 |
| 2 | 3 | 5 | 55 | 1 | 10.43 |
| 3 | Water/pH 6.5 | | | | 23.97 |
| 4 | 3 | 5 | 55 | 1 | 8.5 |

### Integration of Extraction and Pulping

Since one advantage of the present invention is the maximization of extraction recovery while simultaneously maintaining pulp properties, integration of the extraction and pulping steps was needed. In order to accomplish this, pulping rate, yield and pulp properties for chips extracted at the optimal conditions were determined in the ranges shown in FIG. 5 and any necessary adjustments of the extraction and the pulping conditions are made. For example, it has been found that in various embodiments, an Arundo donax pulp may be produced by treating the Arundo donax chips in the temperature range of 90-100° C. for 1-3 hours or 100-130° C. for ¼-1½ hours.

The results from integrated extraction and pulping runs using the Arundo donax stem chips are set forth in the following Table 3.

TABLE 3

| | | | Extraction | | Extract | Pulp | Pulp Tear | Pulp Burst |
|---|---|---|---|---|---|---|---|---|
| Run | NaOH | Peroxide | Temperature | Time | Yield | Yield | Index | Index |
| No. | (% on O.D) | (% on O.D) | (° C.) | (hrs) | (%) | % | mN*m²/g | kPa*m²/g |
| 1 | 10 | 0 | 90 | 2 | 14 | 86 | 2.9 | 1.3 |
| 2 | 10 | 5 | 90 | 2 | 14.8 | 85.2 | 3.4 | 1.4 |
| 3 | 10 | 5 | 90 | 2 | 14 | 86 | 3.2 | 1.4 |
| 4 | 10 | 5 | 92 | 1 | 12.2 | 87.8 | 3.1 | 1.2 |
| 5 | 10 | 5 | 92 | 1 | 10.1 | 89.9 | 3 | 1.3 |
| 6 | 10 | 5 | 92 | 1 | 10.6 | 89.4 | 3 | 1.3 |
| 7 | 10 | 5 | 90 | 1 | 11 | 89 | 3.1 | 1.3 |
| 8 | 10 | 5 | 90 | 1 | 11.6 | 88.4 | 3.7 | 1.4 |
| 9 | 20 | 10 | 95 | 2 | 41.5 | 58.5 | 6.4 | 2.3 |
| 10 | 15 | 10 | 95 | 1.5 | 17.8 | 82.2 | 4.4 | 1.6 |
| 11 | 20 | 10 | 95 | 1 | 48.6 | 51.4 | 6.8 | 2.2 |
| 12 | 20 | 10 | 95 | 2 | | 44.3 | 5.9 | 2 |
| 13 | 10 | 5 | 95 | 3 | 15.9 | 84.1 | 3.9 | 1.5 |
| 14 | 10 | 5 | 106 | 1 | 11 | 89 | 3.3 | 1.4 |
| 15 | 12 | 5 | 110 | 1 | 15 | 85 | 3.9 | 1.5 |
| 16 | 12 | 5 | 110 | 1 | 15.1 | 84.9 | 4.1 | 1.5 |
| 17 | 10 | 5 | 110 | 1 | 14.5 | 85.5 | 3.9 | 1.5 |
| 18 | 10 | 5 | 120 | 1 | 15.3 | 84.7 | 4.4 | 1.6 |
| 19 | 10 | 5 | 130 | 1 | 19.1 | 80.1 | 4.7 | 1.7 |

### Purification of the Hemicellulose Rich Extract

There are two methods for low cost hemicellulose purification. First, since hemicellulose has a relatively high molecular weight (≈25,000 to 200,000) and soluble lignin and plant extractives have a relatively low molecular weight (≈250 to 6,000), membranes with a pore size or cut off size between these ranges permit fairly efficient separation of the high and low MW fractions. For example, commercially available ceramic membranes (such as ultrafiltration membranes available from Pall Corporation) permit separation of narrow MW fractions at low operating cost. These membranes tolerate much more aggressive reverse flow cleaning cycles and can be thoroughly cleaned by heating in muffle furnaces. Accordingly, the membrane life is very long compared to polymer based membranes.

Second, commercial systems are available for acidification and filtration of the resulting precipitated lignin. This type of system is simple and inexpensive, but depending on the lignin properties may be difficult to operate. Furthermore, the extractives which are very deleterious to downstream sugar fermentation or hydrogenation will remain with the hemicellulose and must be removed by a separate operation.

### Purification of the Hemicellulose Rich Extract (i.e., Lignin, Extractive Removal)

Small scale membrane test equipment is used to select the correct membrane pore size for separation of impurities from the hemicellulose fractions generated as described above and to confirm that the separation is feasible. Performance efficiency is measured by the fraction of total available hemicellulose rejected by the membrane and the fraction of available lignin and plant extractives passed through the membrane.

### Production of Sufficient Purified Hemicellulose for Fermentation and Hydrogenation Testing

The downstream fermentation and the hydrogenation steps can tolerate some amount of lignin and plant extractive impurities. Accordingly, for economic reasons, complete purification is not necessary. To determine the quantity of impurities that can be tolerated, purified hemicellulose products containing three different amounts of those impurities are generated. These products are then hydrolyzed to the simple 5 and 6 carbon sugar mixtures and subjected to fermentation testing. The rate of conversion to ethanol, the extent of inhibition by impurities present and the total yield of ethanol or byproducts are measured.

Experimental—Purification Step

Extracts prepared as described in the extraction step noted above are processed in membrane ultrafiltration to produce a membrane retentate stream rich in higher molecular weight, polydisperse hemicellulose fraction (MW≈10,000 to 300,000) and a membrane permeate stream rich in lower molecular weight, alkali soluble, polydisperse lignin (MW≈500 to 5000). The chemical composition, average molecular weight and the molecular weight range of the feed stream depends on Arundo donax agronomic conditions, on age at harvest and on the conditions used in the extraction step noted above. Accordingly, membrane pore size and ultrafiltration operating conditions vary with the source and treatment of the feed. The operating conditions fall in the following range:

Feed stream: 3 to 35% total solids

Temperature: 25 to 50° C.

Membrane molecular weight cut off (MWCO): 1000 to 300,000

Pore size for the above MWCO correspond to: 0.0015 to 0.035 micron

Operating pressure: 0.5 to 5 bar

### Concentration of Hemicellulose to about 20% Solids

Rates of fermentation and hydrogenation and the final yield of either ethanol or glycols blends are directly affected by the concentration of the mixed sugar feed. Typically the results are maximized and the operating costs minimized at 20 to 25% solids in the feed stream, the best operating conditions must be determined for each situation.

Experimental—Concentration Step

The hemicellulose rich retentate streams recovered in the purification step noted above are concentrated to 10 to 35% total solids content using membrane ultrafiltration with a membrane pore size selected to produce a retentate stream rich in polydisperse hemicellulose fractions and a permeate stream consisting primarily of water and low molecular weight inorganic and organic solute species. The optimum pore size for this concentration step depends on the extraction conditions and on the conditions used in the purification step noted above (both affect the molecular weight of the recovered polydisperse hemicellulose and the pore size required to retain that material while passing the lower molecular weight material through the membrane). The operating conditions for this step fall in the ranges:

Feed stream: 3 to 35% total solids

Temperature: 25 to 50° C.

MWCO: 10,00 to 30,000

Corresponding pore size: 0.0015 to 0.0044

Operating pressure: 0.5 to 5 bar

### Integrated Purification and Concentration of the Hemicellulose Rich Stream

Commercial systems are available for evaporative concentration of conventional pulping liquors. Furthermore, other systems have been developed for lignin removal. However, these systems in the present processes can not be used for several reasons. In conventional alkaline pulping systems, the hemicellulose portion of the plant material becomes largely depolymerized producing a complex mixture of chemically modified structures (termed saccharinic acids) that are totally separated from the soluble lignin fraction. These chemical species are too highly modified to be useful for either fermentation or hydrogenation processes. That lignin can then be precipitated by acidification. The resulting precipitate has been isolated by gravity settling or by filtration of the insoluble lignin. This type of system is simple and inexpensive, but the gelatinous, hydrophilic lignin plugs normal filtration media and resists dewatering in either filtration or in settling systems. As a result, these systems are difficult to operate, would be difficult to adapt for practical lignin and hemicellulose separation in the system described herein and have limited practical use for large scale processing.

Furthermore, the biomass treatment conditions described herein are intentionally selected to retain the hemicellulose structure as high molecular weight oligomers. As a result of these mild conditions, chemical interactions between the lignin and the hemicellulose prevent precipitation of soluble lignin from precipitating.

Consequently, new combinations of process steps have been developed that will permit inexpensive concentration of process streams by water removal and the separation of the soluble lignin from hemicellulose derived 5 and 6 carbon sugars. The resulting concentrated and purified sugar mixtures can be used for fermentation or for further chemical processing such as hydrogenation to produce mixtures of simple glycols.

The mild extraction conditions described above result in soluble lignin and hemicellulose oligomers with much different chemical and physical behavior than in conventional pulping processes. Unlike conventional processes these soluble lignin and hemicellulose oligomers are dissolved with minor chemical modification and enter the soluble state as large macromolecules. These large structures are easily retained by membranes of appropriate pore size allowing water, soluble plant extractives and inorganic salts to pass the membrane into the permeate. These macromolecules have a unique and limited tendency to form gelatinous deposits on and near the membrane—solution interface. The paucity of gelatinous deposits permits rapid water removal (concentration) and plant extractive and inorganic salt removal (purification) with far less membrane pluggage and any associated required cleaning cycles or membrane replacement than for similar materials derived from normal high temperature extraction/pulping processes.

### Range of Conditions for Concentration of the Hemicellulose Rich Extract (i.e., Water, Extractive and Inorganic Salt Removal)

Membrane test equipment is used to select the range membrane pore size for appropriate for concentration of the lignin/hemicellulose fractions generated in the extraction step described above. Performance efficiency is measured by the final concentration of retentate, the initial and final permeate flux per unit area and time, the retention of lignin and hemicellulose, the reduction in permeate resin/fatty acid content and its conductivity resulting from transfer of inorganic salts into the permeate.

Experimental—Concentration Step

a. Raw Material

Liquid containing material extracted from Arundo donax as prepared in the extraction step described above and containing dissolved lignin, hemicellulose and plant extractives is treated for removal of water (concentration), resin/fatty acid and soluble inorganic salts. The change in total solids content demonstrates degree of water removal, titration of retentate and permeate measures resin/fatty acid separation and trends in conductivity of permeate indicates transfer of inorganic salts into the permeate. The chemical composition, average molecular weight and the molecular weight range of the feed stream will depend on A. donax agronomic conditions, on age at harvest and on the conditions used in the extraction step described above. Accordingly, as one of skill in the art will appreciate, membrane pore size and ultrafiltration operating conditions will vary with the source and treatment of the feed. Membranes ranging in porosity from about 300 to 30,000 Dalton vary in recovery and in flux rate for this application.

b. Conditions and Results

The liquid extract feed prepared in the extraction step noted above contained 2.83% total solids of which 63% amounted to hemicellulose, 30% lignin, 2% resin and fatty acids, 5% inorganic sodium salts and a conductivity of 12,700 micro Siemens per centimeter. This liquid feed was concentrated to about 23% solids using five different filter media ranging in pore size from “tight”, 250 dalton nanofilters to “open” 30,000 dalton ultrafilters.

The nanofilters and ultrafilters shown in Table 4 ranged in pore size from about 250 Daltons to about 30,000 Daltons and were constructed of various polymeric materials. The complex interaction between soluble macromolecules and the filter media leading to rejection of material or acceptance into the permeate depends heavily on the ratio of pore size opening to swollen, soluble molecule size and to the interaction of the molecules with the particular filter media chemistry. Nanofilters 1-3 and ultrafilters 1-2 increased in pore size. The small pore sizes require higher operating pressure to produce reasonable permeate flows. The permeate contained more solids and higher conductivity as a result of the more material passing through the more open membranes. The most “open” ultrafilter passed nearly all of the small inorganic salts into the permeate since the conductivity was about the same as the feed. All nanofilters produced a colorless permeate containing no lignin so all of that material was rejected by those filters and remained in the retentate. The larger pores of the ultrafilters passed small amounts of the colored lignin into the permeate. All filters passed the resin acid/fatty acid feed content into the permeate since none of that material remained in any retentate.

Finally, the average permeate flux rate was similar for all filters despite the large difference in filter pore size between the tight (nanofilter 1) and the open (ultrafilter 2) filters. This similarity in flux rate despite the wide range in pore sizes relates to the tendency of macromolecules to enter and plug those pores that are larger than the molecules. As a result, despite the large ultrafilter pore sizes, the flux rate did not increase significantly. The optimum membrane will depend on the amount of lignin and inorganic salt contamination that can be accepted by downstream processing requirements such as fermentation and hydrogenation. For this application, the nanofilter 3 may provide the optimum flux rate/inorganic acceptance/colored lignin rejection.

TABLE 4
Example Membrane Dewatering and Purification of Extraction Liquids

| | Average | | Permeate | | |
|---|---|---|---|---|---|
| | Flux | Pressure | Solids | Conductivity | |
| Membrane | (gfd*) | (psig) | (%) | (mS) | Color |
| Nanofilter 1 | 90 | 200 | 0.25 | 3500 | colorless |
| (270 Dalton, | | | | | |
| polyamide) | | | | | |
| Nanofilter 2 | 70 | 200 | 0.46 | 6000 | colorless |
| (300 Dalton, | | | | | |
| thin film, non- | | | | | |
| polyamide) | | | | | |
| Nanofilter 3 | 88 | 200 | 0.53 | 6500 | colorless |
| (500 Dalton, | | | | | |
| thin film, non- | | | | | |
| polyamide) | | | | | |
| Ultrafilter 1 | 70 | 100 | 1.18 | 9800 | very light |
| (polyethersulfone) | | | | | color |
| Ultrafilter 2 | 100 | 100 | 1.78 | 13,000 | light color |
| (regenerated | | | | | |
| cellulose) | | | | | |

*gfd means gallon per square foot per day

### Hydrolysis of Hemicellulose to 5 and 6 Carbon Sugars

Experimental—Hydrolysis Step—Method 1

The purified and concentrated hemicellulose stream derived from the foregoing steps is a polydisperse polymer mixture containing mainly the five and six carbon xylose, glucose, mannose and arabinose sugar structures in the polymer chain with relative quantities of about 90, 6, 3, 1 respectively depending on the biomass source and on the conditions in the foregoing steps. The concentrated stream is treated with a mixture of enzymes consisting of xylanase, cellulase, beta glucosidase and mannonase enzymes that acts to break glycoside between these sugars in the polymer chain and releases xylose, glucose, mannose and arabinose sugars respectively. This action results in a concentrated aqueous solution (at approximately the same solids concentration as the feed to this hydrolysis step) mixture of these sugars appropriate for sale to a third party.

Since hemicellulose composition varies with the raw material and with conditions employed in Steps 1 and 2 the proportion of enzyme used for this hydrolysis step will vary and must be adjusted with each situation. The conditions fall in the following ranges:

Reaction time: 1 to 10 hours

Mass ratio of enzyme/s to sugar/s: 1/5 to 1/50

Temperature: 45 to 55° C.

pH: 4.6 to 5.4

Experimental—Hydrolysis Step—Method 2

A standard condition of 120° C. at pH 4.5 for one hour converts all hemicellulose in these liquid streams into a mixture of 5 and 6 carbon sugars at about 99% yield. The ratio of pentose to hexose sugars depends on the type of biomass feed stock. For Arundo donax, the ratio amounts to about 9/5/3/2 of xylose/glucose/galactose/mannose. Xylose is a 5 carbon sugar while the others are 6 carbon sugars.

### Purification and Concentration of 5 and 6 Carbon Sugar Mixtures

Rates of fermentation and hydrogenation and the final yield of either ethanol or of glycol blends are directly affected by the concentration of the mixed sugar feed. Typically, the results are maximized and the operating costs minimized at 20 to 25% sugar solids in the feed to those processes. Recovery and concentration of simple 5 and 6 carbon sugars from the foregoing steps involves two sequential operations. First, the sugars are separated from the lignin contained in the product of the foregoing step producing a highly purified, sugar rich permeate at from 5 to 15% total solids. Second, this stream is concentrated to about 20-30% solids as preparation for marketing to fermentation or to chemical processing customers.

The small size sugars (low molecular weight) are readily separated from larger molecular weight lignin using the membranes shown in Table 3. Lignin rejection from the permeate is 100% with about 95% sugar recovery in the permeate at flux rates of about 10 gpd. Water removal from the resulting sugar rich permeate requires membranes falling in the reverse osmosis pore size range (30-150 dalton).

Operating Conditions and Results from Concentration of the Sugar Rich Permeate

A raw material solution derived from the hydrolysis step and containing 2.2% mixed sugars was concentrated to 20% total solids using two reverse osmosis membranes of 30 and 40 Daltons, respectively, but made with different chemical composition. The average flux rates were 90 and 150 gfd respectively. The higher flux rate of the latter is a result of different interaction between feed and membrane chemistry. Despite the “tight” reverse osmosis pore size membrane, flux remained nearly constant for an extended period indicating that virtually no pore pluggage occurred in this application and suggesting potentially very long operating times with little down time for membrane cleaning or replacement.

While particular steps, elements, embodiments and applications of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

1. A process for extracting a hemicellulose containing fraction from an Arundo donax biomass comprising treating the Arundo donax biomass in an aqueous solution at a temperature in the range of 40-130° C. and at a pH in the range of 5-12 for ½-5 hours.

2. The process of claim 1 wherein the Arundo donax biomass comprises Arundo donax chips.

3. The process of claim 1 wherein the process yields an extracted Arundo donax biomass.

4. The process of claim 1 wherein the process yields an Arundo donax pulp.

5. The process of claim 1 wherein the aqueous solution comprises hydrogen peroxide.

6. The process of claim 5 wherein the aqueous solution comprises 0-10% by weight hydrogen peroxide.

7. The process of claim 6 wherein the aqueous solution comprises 0-5% by weight hydrogen peroxide.

8. The process of claim 1 wherein the aqueous solution comprises sodium hydroxide.

9. The process of claim 8 wherein the aqueous solution comprises 0-12% by weight sodium hydroxide.

10. The process of claim 1 wherein the temperature is in the range of 40-105° C.

11. The process of claim 1 wherein the temperature is in the range of 45-130° C.

12. The process of claim 1 wherein the temperature is in the range of 40 to less than 90° C., the Arundo donax biomass is treated for ½-4 hours and the process yields an extracted Arundo donax biomass.

13. The process of claim 1 wherein the temperature is in the range of 90-100° C., the Arundo donax biomass is treated for 1-3 hours and the process yields an Arundo donax pulp.

14. The process of claim 1 wherein the temperature is in the range of 100-130° C., the Arundo donax biomass is treated for ½-1½ hours and the process yields an Arundo donax pulp.

15. The process of claim 1 wherein the hemicellulose containing fraction comprises 10-40% by weight hemicellulose.

16. A process for recovering hemicellulose from Arundo donax, comprising:
a) extracting a hemicellulose containing fraction from an Arundo donax biomass as set forth in claim 1;
b) purifying the hemicellulose containing fraction to remove lignin and other extractives;
c) concentrating the purified hemicellulose containing fraction; and
d) hydrolyzing the concentrated and purified hemicellulose containing fraction to yield a 5 and 6 carbon sugar containing fraction.

17. The process of claim 16 wherein steps b) and c) comprise a single purification and concentration step.

18. The process of claim 16, further comprising:
e) purifying the 5 and 6 carbon sugar containing fraction to remove any remaining lignin and other extractives; and
f) concentrating the purified 5 and 6 carbon sugar containing fraction.
